(19) United States
(12) Patent Application Publication
(10) Pub. No.: US 2019/0179087 A1
(43) Pub. Date: Jun. 13, 2019

(54) OPTICAL CONNECTOR FERRULE AND OPTICAL CONNECTOR

(71) Applicants: SUMITOMO ELECTRIC INDUSTRIES, LTD., Osaka-shi, Osaka (JP); SEI Optifrontier Co., Ltd., Yokohama-shi, Kanagawa (JP)

(72) Inventors: Masaki OHMURA, Yokohama-shi, Kanagawa (JP); Masashi OKA, Yokohama-shi, Kanagawa (JP); Tsutomu KAMADA, Yokohama-shi, Kanagawa (JP)

(73) Assignees: SUMITOMO ELECTRIC INDUSTRIES, LTD., Osaka-shi, Osaka (JP); SEI Optifrontier Co., Ltd., Yokohama-shi, Kanagawa (JP)

(21) Appl. No.: 16/325,492

(22) PCT Filed: Jul. 25, 2017
(86) PCT No.: PCT/JP2017/026864

§ 371 Date: Feb. 14, 2019

(30) Foreign Application Priority Data
Oct. 19, 2016 (JP) 2016-205062

(51) Int. Cl. G02B 6/38; G02B 6/40

(52) U.S. Cl. CPC G02B 6/3839; G02B 6/403

(57) ABSTRACT

An optical connector ferrule has a pair of end faces, a plurality of fiber holding holes, and a fiber introduction space having an opening at one end face, communicating with the plurality of fiber holding holes, and receiving the plurality of optical fibers collectively. An inner surface defining the fiber introduction space includes a fiber supporting surface having a plurality of guide grooves formed in such a way as to extend individually from ends of the plurality of fiber holding holes towards the one end face and a pair of first inner lateral surfaces extending individually from both ends of the fiber supporting surface in the second direction. A space between the pair of inner lateral surfaces expands gradually as further away from the fiber supporting surface.

### TECHNICAL FIELD

An aspect of the present invention relates to an optical connector ferrule and an optical connector.

This application claims the benefit of priority based on Japanese Patent Application No. 2016-205062 filed on Oct. 19, 2016, and the entire disclosure of the Japanese Patent Application is incorporated herein by reference.

### BACKGROUND ART

Patent Literature 1 describes a technique regarding a method for producing an optical fiber with a ferrule. The ferrule used in this production method has an insertion opening into which an optical fiber ribbon is inserted, a plurality of optical fiber holes, and an adhesive filling window for filling the plurality of optical fiber holes with an adhesive to fix optical fibers of the optical fiber ribbon to the plurality of optical fiber holes. In this production method, when the optical fiber ribbon is seen from the adhesive filling window, the optical fiber ribbon is inserted from the insertion opening so that a covering peeled edge of the optical fiber ribbon is located in a predetermined position.

### CITATION LIST

### Patent Literature

Patent Literature 1: Japanese Unexamined Patent Publication No. 2011-107633

### SUMMARY OF INVENTION

An optical connector ferrule according to an embodiment has a pair of end faces aligned in a first direction, a plurality of fiber holding holes extending in the first direction between the pair of end faces, and aligned in a second direction intersecting the first direction to hold a plurality of optical fibers individually, and a fiber introduction space having an opening at one end face, communicating with the plurality of fiber holding holes, and receiving the plurality of optical fibers collectively. An inner surface defining the fiber introduction space includes a fiber supporting surface having a plurality of guide grooves formed in such a way as to extend individually from ends of the plurality of fiber holding holes towards the one end face and a pair of first inner lateral surfaces extending individually from both ends of the fiber supporting surface in the second direction. A space between the pair of first inner lateral surfaces expands gradually as further away from the fiber supporting surface.

### BRIEF DESCRIPTION OF DRAWINGS

FIG. 1 illustrates a sectional view of an optical connector according to an embodiment, the sectional view illustrating a side section taken along a connecting direction.

FIG. 2 is a plan view illustrating a distal end portion of an optical fiber ribbon.

FIG. 3 is a sectional view taken along a line Ill-Ill in FIG. 2.

FIG. 4 is a sectional view illustrating a side section taken along a connecting connection of the optical connector ferrule.

FIG. 5 illustrates a sectional view taken along a line V-V in FIG. 4, the sectional view illustrating a section taken along an XY plane.

FIG. 6 illustrates a sectional view taken along a line VI-VI in FIG. 4, the sectional view illustrating a section taken along an XZ plane.

FIG. 7A is a drawing schematically illustrating how a plurality of optical fibers are mounted in an optical connector ferrule as a comparison example, the drawing being a plan view of the plurality of optical fibers and a fiber supporting surface.

FIG. 7B is a drawing schematically illustrating how the plurality of optical fibers are mounted in the optical connector ferrule as the comparison example, the drawing being a sectional view of the plurality of optical fibers and the fiber supporting surface.

FIG. 8A is a drawing schematically illustrating how the plurality of optical fibers are mounted in the optical connector ferrule as the comparison example, the drawing being the plan view of the plurality of optical fibers and the fiber supporting surface.

FIG. 8B is a drawing schematically illustrating how the plurality of optical fibers are mounted in the optical connector ferrule as the comparison example, the drawing being a sectional view of the plurality of optical fibers and the fiber supporting surface.

FIG. 9A is a drawing schematically illustrating how a plurality of optical fibers are mounted in an optical connector ferrule of the embodiment, the drawing being a plan view of the plurality of optical fibers and the fiber supporting surface.

FIG. 9B is a drawing schematically illustrating how the plurality of optical fibers are mounted in the optical connector ferrule of the embodiment, the drawing being a sectional view of the plurality of optical fibers and the fiber supporting surface.

FIG. 10 is a sectional view showing a first modified example, the sectional view illustrating a section taken along an XY plane of a fiber introduction space.

FIG. 11 is a sectional view showing a second modified example, the sectional view illustrating a section taken along an XY plane of a fiber introduction space.

FIG. 12 is a sectional view showing a third modified example, the sectional view illustrating a section taken along an XZ plane of a fiber introduction space.

FIG. 13 is a sectional view showing a fourth modified example, the sectional view illustrating a section taken along an YZ plane of a fiber introduction space.

### DESCRIPTION OF EMBODIMENTS

### Technical Problem

When producing an optical connector including a multiple-core optical connector ferrule such as an MT ferrule, firstly, a covering of a distal end portion of an optical fiber ribbon is removed, and a plurality of optical fibers are separated. Next, the plurality of optical fibers are inserted from an opening at a rear end of the ferrule while maintaining the state where the plurality of optical fibers separated from one another are aligned into the row. Then, the plurality of optical fibers are caused to move forwards gradually while the plurality of optical fibers are caused to follow individually a plurality of guide grooves formed in an interior of the multiple-core optical connector ferrule. By doing so, the plurality of optical fibers are inserted into a plurality of fiber holding holes each communicating with each of the plurality of guide grooves. Thereafter, the optical fiber ribbon and the plurality of optical fibers which are separated from one another are fixed to the multiple-core optical connector ferrule with an adhesive.

In the optical connector production process described above, it is necessary to cause the individual optical fibers to follow the corresponding guide grooves in an ensured manner. This is because when the positions of the individual optical fibers deviate from the guide grooves, distal ends of the optical fibers come to collide with a portion other than the fiber holding holes when the optical fibers are caused to move forwards, leading to fears that the optical fibers are damaged. However, a diameter of each optical fiber is extremely thin, such as 125 μm, and an inter-center interval (pitch) between the optical fibers is also extremely narrow. Thus, it is not easy to cause each optical fiber to follow the corresponding guide groove in an ensured manner visually by the operator, resulting in a problem in that skill is required to perform this operation properly.

This disclosure has been made in view of this problem, and an object thereof is to provide an optical connector ferrule and an optical connector which can enable each optical fiber to follow its corresponding guide groove easily.

### Advantageous Effect of the Disclosure

According to the optical connector ferrule and the optical connector of this disclosure, each optical fiber is allowed to follow easily its corresponding guide groove.

### Description of Embodiment

Firstly, the contents of an embodiment of this disclosure will be described. An optical connector ferrule according to an embodiment has a pair of end faces aligned in a first direction, a plurality of fiber holding holes extending in the first direction between the pair of end faces, and aligned in a second direction intersecting the first direction to hold a plurality of optical fibers individually, and a fiber introduction space having an opening at one end face, communicating with the plurality of fiber holding holes, and receiving the plurality of optical fibers collectively. An inner surface defining the fiber introduction space includes a fiber supporting surface having a plurality of guide grooves formed in such a way as to extend individually from ends of the plurality of fiber holding holes towards the one end face and a pair of first inner lateral surfaces extending individually from both ends of the fiber supporting surface in the second direction. A space between the pair of first inner lateral surfaces expands gradually as further away from the fiber supporting surface.

In this optical connector ferrule, the pair of first inner lateral surfaces that extend individually from both the ends of the surface (the fiber supporting surface) on which the plurality of guide grooves are formed are included in the inner surface that defines the fiber introduction space. Then, the space between the pair of first inner lateral surfaces expands gradually as further away from the fiber supporting surface. By adopting this configuration, when the plurality of optical fibers that are aligned in the second direction are moved towards the plurality of guide grooves from a position that faces the fiber supporting surface, the optical fibers that are positioned at both the lateral ends of the aligned optical fibers are guided by the pair of first inner lateral surfaces. As a result, the individual optical fibers can move on to their corresponding guide grooves with good positional accuracy. Thus, according to this optical connector ferrule, the individual optical fibers can be caused to follow their corresponding guide grooves easily.

In the optical connector ferrule described above, the pair of first inner lateral surfaces may be flat, and a normal of each of the pair of first inner lateral surfaces may be inclined relative to the second direction. This enables the pair of first inner lateral surfaces to be formed easily.

In the optical connector ferrule described above, in a section normal to the first direction, the pair of first inner lateral surfaces are curved. This can deflect a force applied to the optical fibers when the optical fibers come into contact with the pair of first inner lateral surfaces, and therefore, the damage to the optical fibers can be suppressed further.

In the optical connector ferrule described above, the inner surface defining the fiber introduction space may include further a pair of second inner lateral surfaces extending individually from ends of the pair of first inner lateral surfaces in the first direction towards the opening, and a space between the pair of second inner lateral surfaces may expand gradually as further away from the pair of first inner lateral surfaces. By adopting this configuration, when the plurality of optical fibers are caused to move towards the plurality of guide grooves along the first direction from the opening side, the optical fibers located at both the lateral ends are guided by the pair of second inner lateral surfaces. As a result, the individual optical fibers can move on to their corresponding guide grooves with good positional accuracy. Thus, according to this optical connector ferrule, the individual optical fibers can be caused to follow their corresponding guide grooves easily.

In the optical connector ferrule described above, the pair of second inner lateral surfaces are flat, and a normal of each of the pair of second inner lateral surfaces is inclined relative to the second direction.

This enables the pair of second inner lateral surfaces to be formed easily.

In the optical connector ferrule described above, in a section including the first direction and the second direction, the pair of second inner lateral surfaces may curved convexly towards the fiber introduction space. This can make boundary portions between the pair of first inner lateral surfaces and the pair of second inner lateral surfaces smoother, and therefore, the damage to the optical fibers can be suppressed further.

In the optical connector ferrule described above, the inner surface defining the fiber introduction space may include further a bottom surface extending from an end of the fiber supporting surface in the first direction towards the opening, and the bottom surface may extend away from an imaginary plane including the fiber supporting surface as further away from the fiber supporting surface. By adopting this configuration, when the plurality of optical fibers are caused to move from the opening side towards the plurality of guide grooves along the first direction, even though the position of the plurality of optical fibers is lower than the fiber supporting surface, the plurality of optical fibers are guided on to the fiber supporting surface by the bottom surface. Consequently, according to this optical connector ferrule, the individual optical fibers can be caused to follow their corresponding guide grooves easily.

In the optical connector ferrule described above, the bottom surface may be flat and be inclined relative to the first direction. This enables the bottom surface to be formed easily.

In the optical connector ferrule described above, in a section normal to the second direction, the bottom surface may be curved convexly towards the fiber introduction space. This can make a boundary portion between the fiber supporting surface and the bottom surface smoother, and therefore, the damage to the optical fibers can be suppressed further.

An optical connector according to the embodiment comprises the optical connector ferrule according to any one of the above aspects, and the plurality of optical fibers introduced into the fiber instruction space collectively from the opening and held individually in the plurality of fiber holding holes. According to this optical connector, by comprising any one of the optical connector ferrules, the individual optical fibers can be caused to follow their corresponding guide grooves easily. This can provide the optical connector in which the damage to the optical fibers is reduced and which has a high reliability.

### Details of the Embodiment

A specific example of the optical connector ferrule and the optical connector according to the embodiment of this disclosure will be described as below by reference to drawings. The present invention is not limited to these specific examples and is intended to include all modifications that are defined by the scope of claims, have equivalent meanings to the scope of the claims and fall in the scope of the claims. In the following description, like reference numerals are given to like elements so as to omit the repetition of similar descriptions in descriptions made by reference to the drawings.

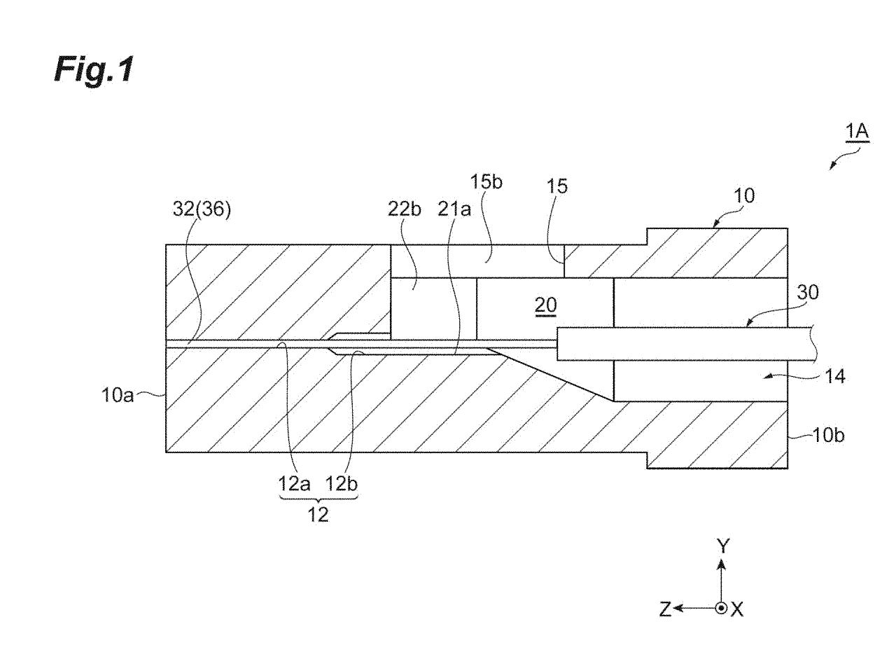

FIG. 1 is a sectional view of an optical connector 1A according to an embodiment, the sectional view illustrating a side section taken along a connecting direction. For easy understanding, an XYZ orthogonal coordinate system is illustrated in FIG. 1, and a Z direction coincides with the connecting direction. In this embodiment, the Z direction is an example of a first direction, and an X direction is an example of a second direction. The optical connector 1A of this embodiment is, for example, an MPO connector. As illustrated in FIG. 1, this optical connector 1A includes an optical fiber ribbon 30, and an optical connector ferrule 10 that is attached to a distal end portion of the optical fiber ribbon 30.

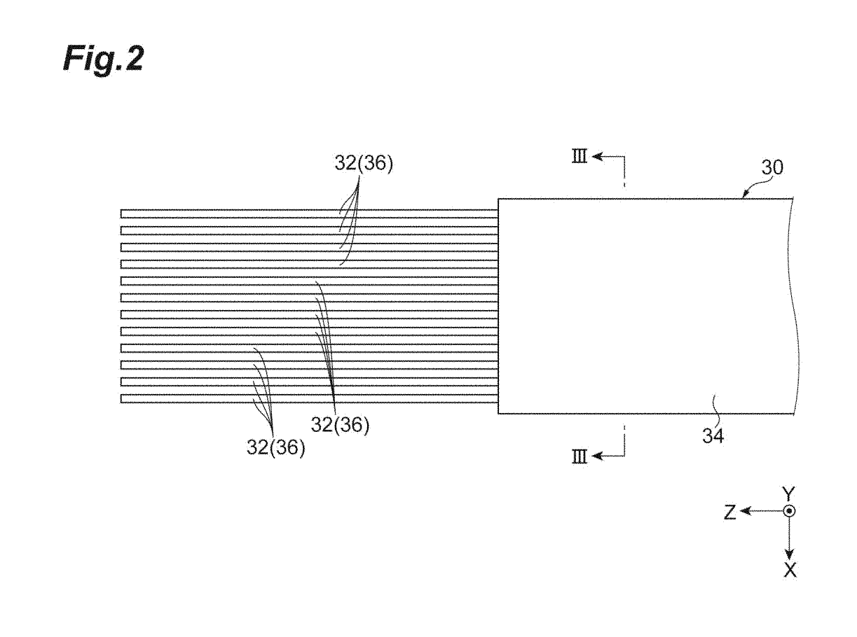

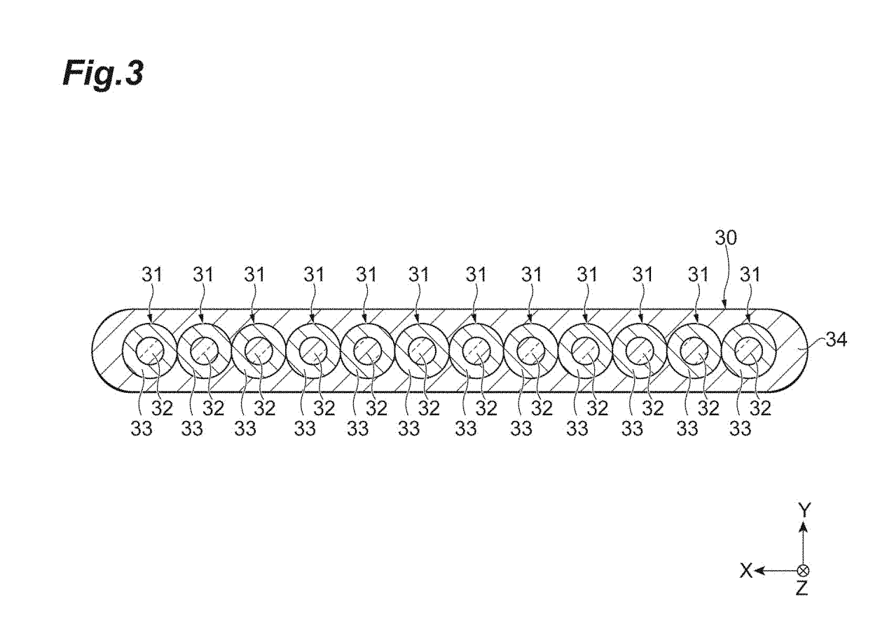

FIG. 2 is a plan view illustrating the distal end portion of the optical fiber ribbon 30. FIG. 3 is a sectional view taken along a line in FIG. 2. As shown in FIG. 3, the optical fiber ribbon 30 is formed by fixing a plurality of (for example, 12) optical fibers 31 that are aligned into the row along the X direction to one another. Each optical fiber 31 has a glass portion 32 having a circular cross section and a first resin covering 33 configured to cover a circumference of the glass portion 32. Then, these optical fibers 31 are covered collectively by a second resin covering 34, whereby the optical fiber ribbon 30 is made up. A diameter of the glass portion 32 is, for example, 125 μm, an outside diameter of the first resin covering 33 is, for example, 250 μm. An inter-center interval between the optical fibers 31 is, for example, 250 μm.

As illustrated in FIG. 2, a plurality of bare fibers 36 are separated from one another at the distal end portion of the optical fiber ribbon 30. Specifically, the second resin covering 34 and the first resin coverings 33 illustrated in FIG. 3 are removed, and the individual optical fibers consist of the bare fibers 36 made up only of the glass portions 32 and are independent of one another. The bare fibers 36 are arranged in such a way as to be aligned in the X direction and extend in the Z direction which constitutes a longitudinal direction (an optical axis direction) of the bare fibers 36.

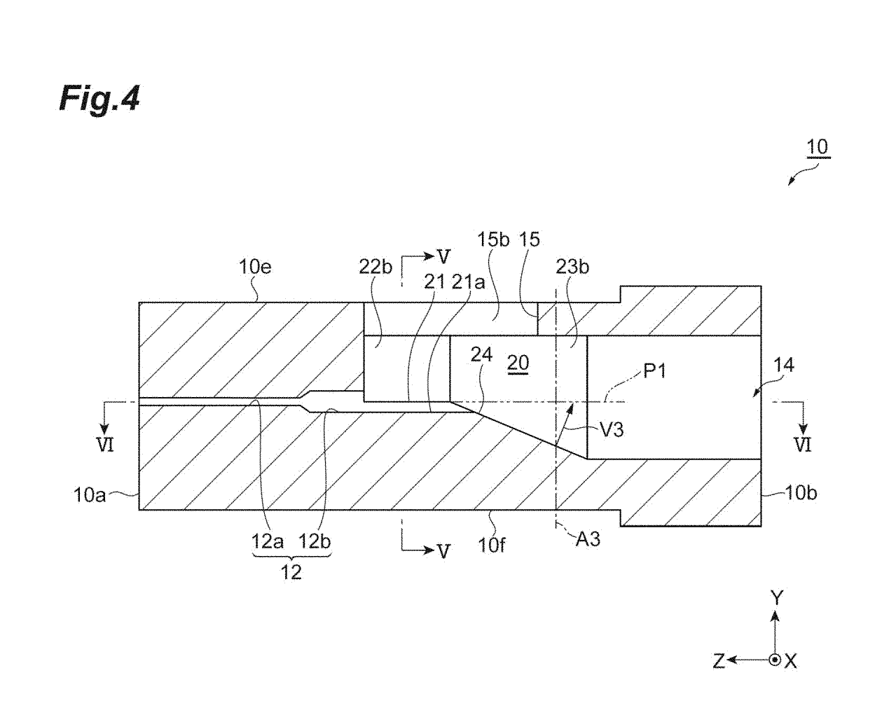

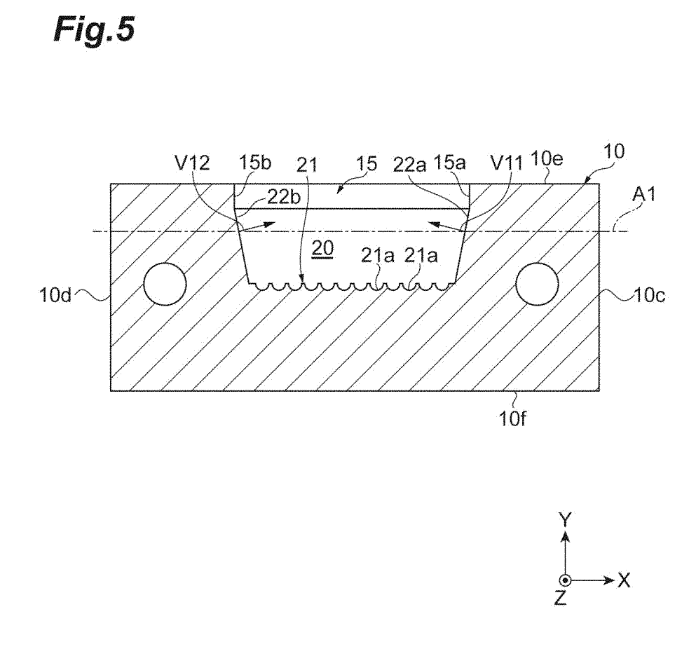

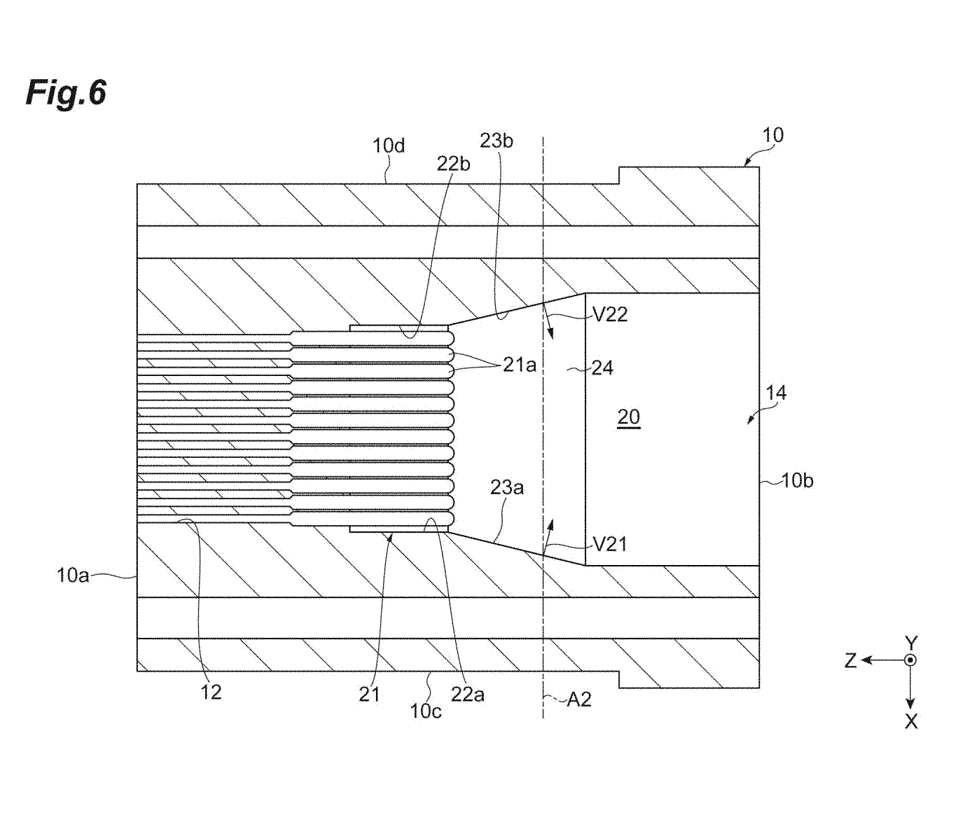

FIG. 4 is a sectional view illustrating a side section taken along the connecting direction of the optical connector ferrule 10 (a section taken along a YZ plane). FIG. 5 is a sectional view taken along a line V-V in FIG. 4, illustrating a section taken along an XY plane. FIG. 6 is a sectional view taken along a line VI-VI in FIG. 4, illustrating a section taken along an XZ plane.

The optical connector ferrule 10 of this embodiment is, for example, an MT ferrule. The optical connector ferrule 10 has an external appearance of a substantially rectangular parallelepiped shape and has a pair of end faces of a front end face 10a and a rear end face 10b that are aligned (face each other) in the Z direction, a pair of lateral surfaces 10c, 10d that are aligned (face each other) in the X direction, and an upper surface 10e and a lower surface 10f that are aligned (face each other) in the Y direction. The optical connector ferrule 10 is made of a resin (for example, a PPS resin) and is formed through molding or injection molding.

The optical connector ferrule 10 has a plurality of fiber holding holes 12. The plurality of fiber holding holes 12 are formed between the front end face 10a and the rear end face 10b in an area lying closer to the front end face 10a. The plurality of fiber holding holes 12 are formed in such a manner that the fiber holding holes 12 extend in the Z direction and are aligned in the X direction. A shape of a section of each fiber holding hole 12 that is normal to the Z direction is circular. The individual optical fibers (the bare fibers 36 in this embodiment) are inserted into their corresponding fiber holding holes 12, and the individual fiber holding holes 12 hold their corresponding optical fibers (the bare fibers 36). In this embodiment, one end of the individual fiber holding holes 12 is opened to the front end face 10a. The fiber holding holes 12 each have a front portion 12a configured to hold the bare fiber 36 and a rear portion 12b configured to facilitate the insertion of the bare fiber 36. An inside diameter of the front portion 12a is smaller than an inside diameter of the rear portion 12b and is slightly greater than a diameter of the bare fiber 36 (that is, a diameter of the glass portion 32). The inside diameter of the rear portion 12b is in a range of 180 μm to 250 μm and is preferably 190 μm. Then, an adhesive is caused to flow into a gap between the fiber holding hole 12 and the bare fiber 36, whereby the bare fiber 36 is fixed to the fiber holding hole 12.

The optical connector ferrule 10 has a fiber introduction space 20. The fiber introduction space 20 has an opening 14 in the rear end face 10b and extends forwards from the rear end face 10b along the Z direction. Then, a front end of the fiber introduction space 20 connects to the rear portions 12b of the plurality of fiber holding holes 12. As illustrated in FIG. 1, the plurality of optical fibers (the bare fibers 36 in this embodiment) are introduced collectively into the fiber introduction space 20 from the opening 14, and the fiber introduction space 20 receives these optical fibers collectively. A rectangular adhesive introduction window 15 is formed in the upper surface 10e of the optical connector ferrule 10, and a front portion of the fiber introduction space 20 connects to the adhesive introduction window 15.

Here, the fiber introduction space 20 will be described in detail. An inner surface of the optical connector ferrule 10 that defines the fiber introduction space 20 of this embodiment includes, as illustrated in FIG. 5, a fiber supporting surface 21, and a pair of first inner lateral surfaces 22a, 22b. The fiber supporting surface 21 is a surface extending from the front end of the fiber introduction space 20 towards the rear end face 10b. The fiber supporting surface 21 is located on a rear side of the lower surface 10f and follows the XZ plane. A position of the fiber supporting surface 21 in the Y direction is substantially equal to a position of the plurality of fiber holding holes 12 in the Y direction. A plurality of guide grooves 21a are formed on the fiber supporting surface 21. The individual guide grooves 21a extend from ends of the individual fiber holding holes 12 towards the rear end face 10b along the Z direction. A section of each guide groove 21a that is normal to its longitudinal direction (the Z direction) is, for example, semi-circular. A radius of the semi-circle is, for example, equal to a radius of the rear portion 12b of the fiber holding hole 12. The plurality of guide grooves 21a are formed in such a manner as to be aligned parallel to one another in the X direction.

One first inner lateral surface 22a is located on a rear side of one lateral surface 10c and extends from one end of the fiber supporting surface 21 in the X direction to an inner lateral surface 15a of the adhesive introduction window 15 in a direction that intersects the X direction. The other first inner lateral surface 22b is located on a rear side of the other lateral surface 10d and extends from the other end of the fiber supporting surface 21 in the X direction to an inner lateral surface 15b of the adhesive introduction window 15 in the direction that intersects the X direction. Edges of sides (sides at the upper surface 10e) of the first inner lateral surfaces 22a, 22b which is situated opposite sides at the fiber supporting surface 21 may reach the upper surface 10e or may be located between the fiber supporting surface 21 and the inner lateral surfaces 15a, 15b of the adhesive introduction window 15.

A space between the first inner lateral surfaces 22a, 22b gradually expands as further away from the fiber supporting surface 21. In this embodiment, the first inner lateral surfaces 22a, 22b are both flat, and respective normal vectors V11, V12 of the first inner lateral surfaces 22a, 22b are inclined towards the adhesive introduction window 15 relative to an axis Al extending in the X direction. In other words, the first inner lateral surfaces 22a, 22b are both inclined outwards of the fiber introduction space 20 relative to a YZ plane from ends of the fiber supporting surface 21 as starting points. In one example, the first inner lateral surfaces 22a, 22b are parallel to an axis (a center axis of the optical connector ferrule 10) that extends in the Z direction.

As illustrated in FIG. 6, the inner surface of the optical connector ferrule 10 that defines the fiber introduction space 20 of this embodiment further includes a pair of second inner lateral surfaces 23a, 23b. One second inner lateral surface 23a is located on a rear side of one lateral surface 10c and extends from an end of the first inner lateral surface 22a in the Z direction towards the opening 14 of the fiber introduction space 20. The other second inner lateral surface 23b is located on a rear side of the other lateral surface 10d and extends from an end of the other first inner lateral surface 22b in the Z direction towards the opening 14 of the fiber introduction space 20. Rear end edges of the second inner lateral surfaces 23a, 23b may reach the opening 14 or may be located between the first inner lateral surfaces 22a, 22b and the opening 14.

A space between the second inner lateral surfaces 23a, 23b expands gradually as further away from the first inner lateral surfaces 22a, 22b, respectively. In this embodiment, the second inner lateral surfaces 23a, 23b are both flat, and respective normal vectors V21, V22 of the second inner lateral surfaces 23a, 23b are inclined towards the opening 14 relative to an axis A2 extending in the X direction. In other words, the second inner lateral surfaces 23a, 23b are both inclined outwards of the fiber introduction space 20 relative to the YZ plane from ends of the first inner lateral surfaces 22a, 22b that faces the rear end face 10b as starting points.

As illustrated in FIG. 4, the inner surface of the optical connector ferrule 10 that defines the fiber introduction space 20 of the embodiment further includes a bottom surface 24. The bottom surface 24 is located on a rear side of the lower surface 10f and extends from an end of the fiber supporting surface 21 in the Z direction towards the opening 14 of the fiber introduction space 20. A rear end edge of the bottom surface 24 may reach the opening 14 or may be located between the fiber supporting surface 21 and the opening 14. The bottom surface 24 is formed in such a manner as to gradually extend away from an imaginary plane P1 including the fiber supporting surface 21 as further away from the fiber supporting surface 21. In this embodiment, the bottom surface 24 is flat, and a normal vector V3 of the bottom surface 24 is inclined towards the opening 14 relative to an axis A3 extending in the Y direction. In other words, the bottom surface 24 is inclined outwards of the fiber introduction space 20 relative to the XZ plane from an end of the fiber supporting surface 21 which faces the opening 14 as a starting point. In one example, the bottom surface 24 is parallel to an axis extending in the X direction.

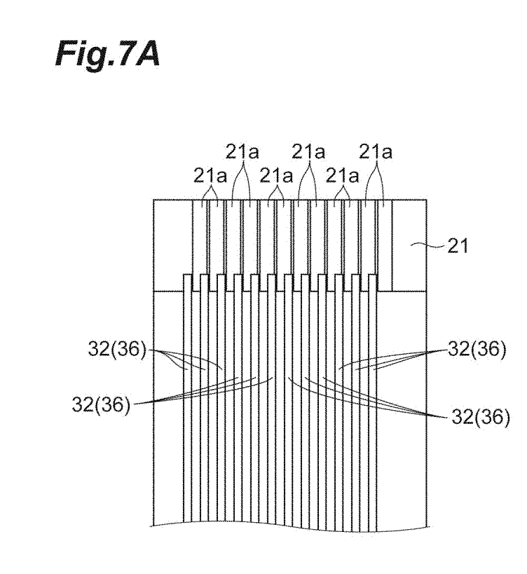

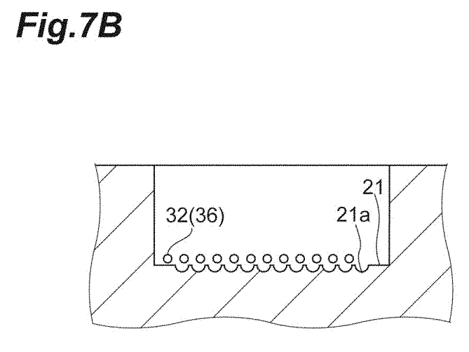

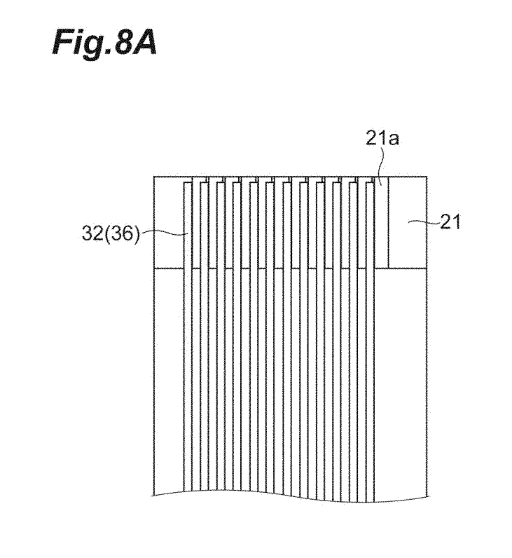

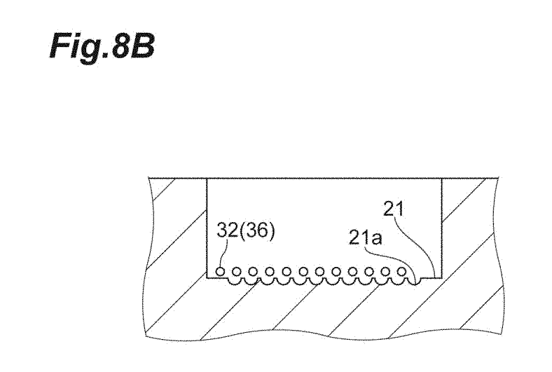

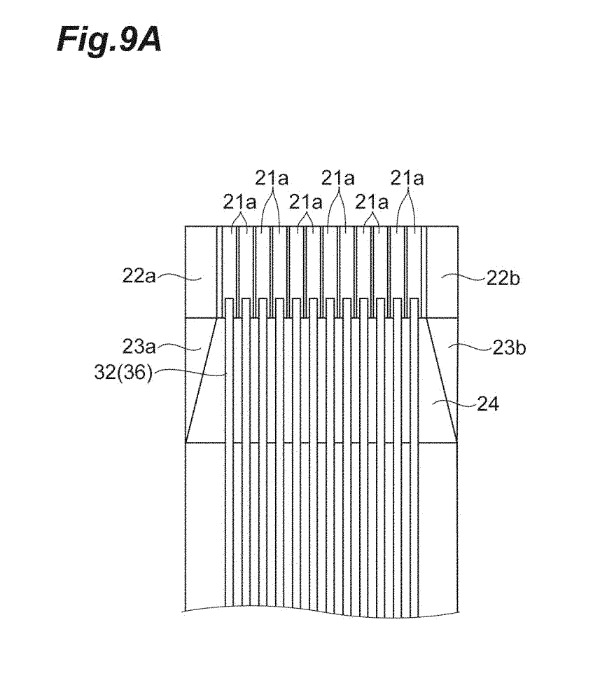

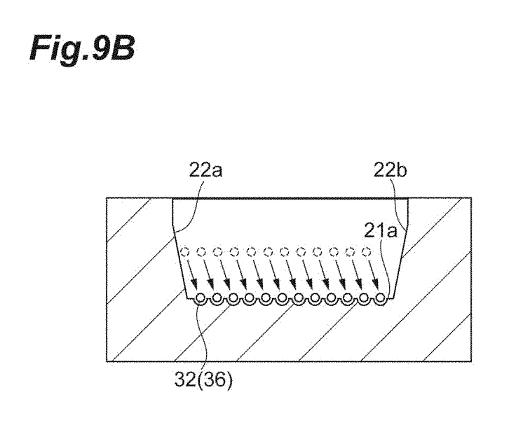

Advantageous effects will be described which are obtained by the optical connector IA and the optical connector ferrule 10 according to this embodiment which have been described heretofore. FIGS. 7A, 7B, 8A, and 8B are drawings illustrating schematically how a plurality of bare fibers 36 are attached to an optical connector ferrule as a comparison example. FIGS. 9A and 9B are drawings illustrating schematically how the plurality of bare fibers 36 are attached to the optical connector ferrule 10 of the embodiment. FIGS. 7A, 8A and 9A are plan views of the plurality of bare fibers 36 and the fiber supporting surface 21. FIGS. 7B, 8B and 9B are sectional views of the plurality of bare fibers 36 and the fiber supporting surface 21.

Normally, when a plurality of optical fibers are attached to an optical connector ferrule, a plurality of bare fibers 36 are moved on to a fiber supporting surface 21, and the plurality of bare fibers 36 are disposed individually in a plurality of guide grooves 21a. Then, the plurality of bare fibers 36 are pushed out forwards in the Z direction while keeping the bare fibers 36 staying in the corresponding guide grooves 21a, whereby the plurality of bare fibers 36 are inserted individually into a plurality of fiber holding holes 12. Here, as shown in FIGS. 7A and 7B, when the positions of the plurality of bare fibers 36 deviate from the guide grooves 21a when the plurality of bare fibers 36 are moved on to the fiber supporting surface 21, as shown in FIGS. 8A and 8B, distal ends of the bare fibers 36 come to collide against portions other than the fiber holding holes 12 when the bare fibers 36 are caused to advance, leading to fears that the bare fibers 36 are damaged. Specifically, when the bare fibers 36 are pushed in excessively with the distal ends of the bare fibers 36 having come to collide against the portions other than the fiber holding holes 12, the bare fibers 36 are disconnected, requiring a distal end portion of an optical fiber ribbon 30 to be worked again. Alternatively, advancing the bare fibers 36 again and again repeatedly damages surfaces of the bare fibers 36 due to the contact with the guide grooves 21a, leading to a possibility of disconnection of the optical fibers, and this changes the optical propagation properties of the optical fibers. However, the bare fibers 36 are extremely thin, and the inter-center interval (pitch) between the bare fibers 36 is also extremely narrow. Consequently, it is not easy to cause the individual bare fibers 36 to follow the corresponding guide grooves 21a in an ensured manner visually by the operator, leading to a problem in that skill is required.

To cope with the problem described above, with the optical connector ferrule 10 of this embodiment, as illustrated in FIGS. 9A and 9B, when the plurality of bare fibers 36 are caused to move towards the plurality of guide grooves 21a from the position facing the fiber supporting surface 21, the bare fibers 36 located at both the ends of the plurality of bare fibers 36 are guided by the pair of first inner lateral surfaces 22a, 22b. As a result, the individual bare fibers 36 can move on to the corresponding guide grooves 21a with good positional accuracy. Consequently, according to the optical connector ferrule 10, since the individual bare fibers 36 can easily be caused to follow the corresponding guide grooves 21a, a risk of the distal ends of the bare fibers 36 being brought into collision against portions other than the fiber holding holes 12 can be reduced. This can not only reduce a risk of disconnection of the bare fibers 36 to suppress an increase in production cost but also reduce the damage made to surfaces of the bare fibers 36, and therefore, it is possible to provide the highly reliable optical connector 1A.

As in this embodiment, the space between the pair of second inner lateral surfaces 23a, 23b may gradually expand as further away from the pair of first inner lateral surfaces 22a, 22b, respectively. By adopting this configuration, when the plurality of bare fibers 36 are caused to move towards the plurality of guide grooves 21a from the opening 14 side along the Z direction, the bare fibers 36 located at both the ends of the plurality of bare fibers 36 are guided by the second inner lateral surfaces 23a, 23b. As a result, the individual bare fibers 36 can move onto the corresponding guide grooves 21a with good positional accuracy, and therefore, the individual bare fibers 36 can easily be caused to follow the corresponding guide grooves 21a.

As in this embodiment, the bottom surface 24 may gradually extend away from the imaginary plane P1 including the fiber supporting surface 21 as further away from the fiber supporting surface 21. By adopting this configuration, when the plurality of bare fibers 36 are caused to move towards the plurality of guide grooves 21a from the opening 14 side along the Z direction, even though the positions of the plurality of bare fibers 36 are lower than the fiber supporting surface 21, the plurality of bare fibers 36 are guided up to the fiber supporting surface 21 by the bottom surface 24. Consequently, the individual bare fibers 36 can easily be caused to follow the corresponding guide grooves 21a.

As in this embodiment, the first inner lateral surfaces 22a, 22b, the second inner lateral surfaces 23a, 23b, and the bottom surface 24 may be flat. By adopting this configuration, the shape of a mold for molding the optical connector ferrule 10 is simplified, whereby the first inner lateral surfaces 22a, 22b, the second inner lateral surfaces 23a, 23b and the bottom surface 24 can be formed easily. At least one of the first inner lateral surfaces 22a, 22b, the second inner lateral surfaces 23a, 23b and the bottom surface 24 may be a smooth surface that is not flat (for example, a curved surface). Even in such a case, the advantageous effects of the embodiment can be provided.

### FIRST MODIFIED EXAMPLE

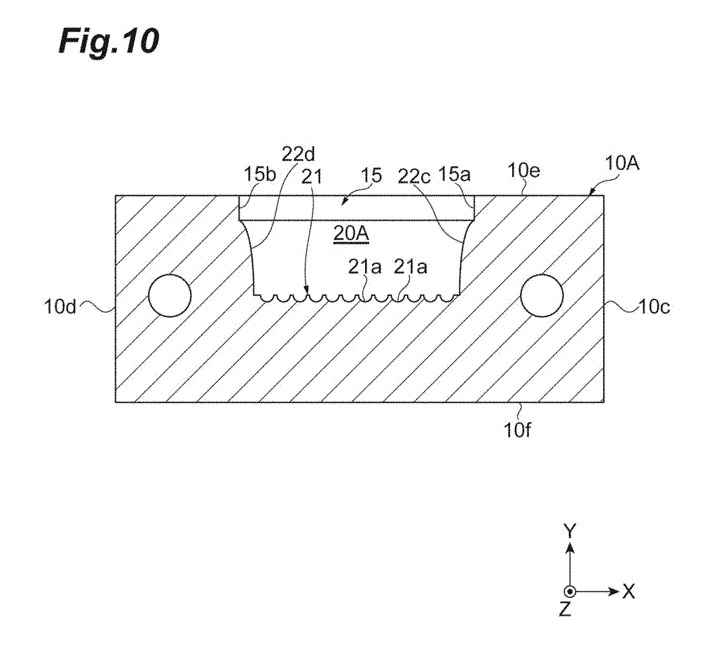

FIG. 10 is a sectional view illustrating a first modified example, the sectional view illustrating a section taken along an XY plane of an optical connector ferrule 10A (a section corresponding to FIG. 5 of the embodiment). The optical connector ferrule 10A of this modified example has a fiber introduction space 20A. An inner surface of the fiber introduction space 20A includes first inner lateral surfaces 22c, 22d in place of the first inner lateral surfaces 22a, 22b of the embodiment. In the section, the first inner lateral surfaces 22c, 22d are shaped so that a space between the first inner lateral surfaces 22c, 22d gradually expand as further away from a fiber supporting surface 21 and are shaped into a convexly curved surface towards an inside of the fiber introduction space 20A. By adopting this configuration, the individual bare fibers 36 can more easily be caused to follow corresponding guide grooves 21a, and a force applied to the bare fibers 36 when the bare fibers 36 come into contact with the first inner lateral surfaces 22c, 22d can be deflected. Thus, the damage to the bare fibers 36 can be suppressed further, and hence, the reliability of the optical connector can be enhanced further. The other configurations of the fiber introduction space 20A excluding the first inner lateral surfaces 22c, 22d remain the same as those of the fiber introduction space 20 of the embodiment.

### SECOND MODIFIED EXAMPLE

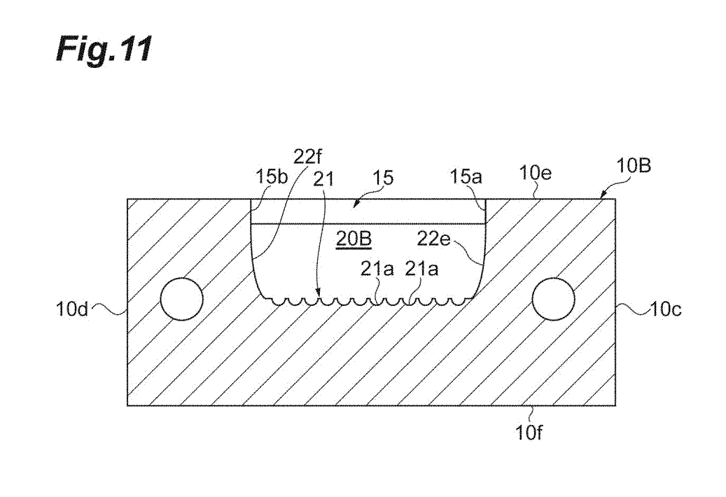

FIG. 11 is a sectional view illustrating a second modified example, illustrating a section taken along an XY plane of an optical connector ferrule 10B (a section corresponding to FIG. 5 of the embodiment). The optical connector ferrule 10B of this modified example has a fiber introduction space 20B. An inner surface of the fiber introduction space 20B includes first inner lateral surfaces 22e, 22f in place of the first inner lateral surfaces 22a, 22b of the embodiment. In the section, the first inner lateral surfaces 22e, 22f are shaped so that a space between the first inner lateral surfaces 22e, 22f gradually expand as further away from a fiber supporting surface 21 and are shaped into a convexly curved surface towards an outside of the fiber introduction space 20B. Even with this form, a force applied to the bare fibers 36 when the bare fibers 36 come into contact with the first inner lateral surfaces 22e, 22f can be deflected, and therefore, the damage to the bare fibers 36 can be suppressed further, thereby making it possible to enhance further the reliability of the optical connector. The other configurations of the fiber introduction space 20B excluding the first inner lateral surfaces 22e, 22f remain the same as those of the fiber introduction space 20 of the embodiment.

### THIRD MODIFIED EXAMPLE

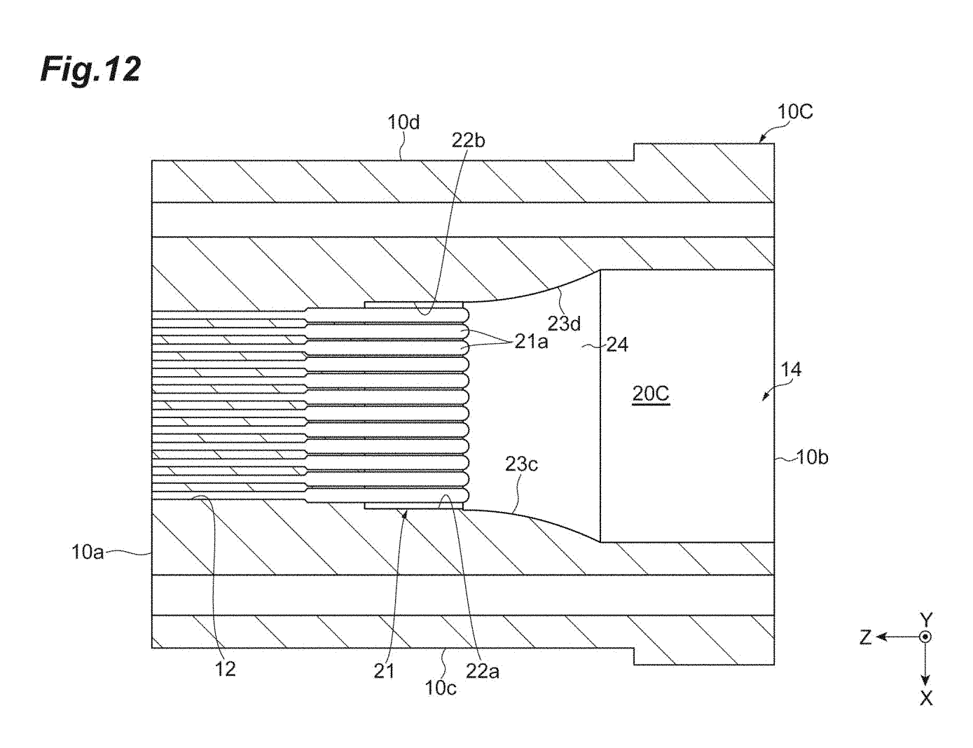

FIG. 12 is a sectional view illustrating a third modified example, the sectional view illustrating a section taken along an XZ plane of an optical connector ferrule 10C (a section corresponding to FIG. 6 of the embodiment). The optical connector ferrule 10C of this modified example has a fiber introduction space 20C. An inner surface of the fiber introduction space 20C includes second inner lateral surfaces 23c, 23d in place of the second inner lateral surfaces 23a, 23b of the embodiment. In the section, the second inner lateral surfaces 23c, 23d are shaped so that a space between the second inner lateral surfaces 23c, 23d gradually expand as further away from first inner lateral surfaces 22a, 22b and are shaped into a convexly curved surface towards an inside of the fiber introduction space 20C. By adopting this configuration, the individual bare fibers 36 can more easily be caused to follow corresponding guide grooves 21a, and boundary portions between the first inner lateral surfaces 22a, 22b and the second inner lateral surfaces 23c, 23d can be made smoother. Consequently, the damage to the bare fibers 36 can be suppressed further, thereby making it possible to enhance further the reliability of the optical connector.

### FOURTH MODIFIED EXAMPLE

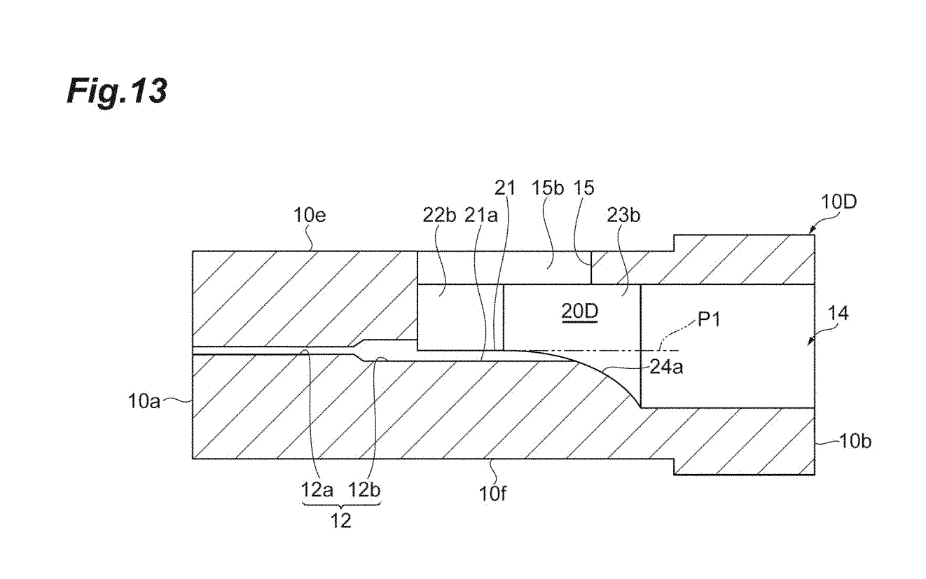

FIG. 13 is a sectional view illustrating a fourth modified example, the sectional view illustrating a section taken along a YZ plane of an optical connector ferrule 10D (a section corresponding to FIG. 4 of the embodiment). The optical connector ferrule 10D of this modified example has a fiber introduction space 20D. An inner surface of the fiber introduction space 20D includes a bottom surface 24a in place of the bottom surface 24 of the embodiment. In the section, the bottom surface 24a is shaped so that the bottom surface 24a gradually extends away from an imaginary plane P1 including a fiber supporting surface 21 as further away from the fiber supporting surface 21 and is shaped into a convexly curved surface towards an inside of the fiber introduction space 20D. By adopting this configuration, the individual bare fibers 36 can more easily be caused to follow corresponding guide grooves 21a, and a boundary portion between the fiber supporting surface 21 and the bottom surface 24a can be made smoother. Consequently, the damage to the bare fibers 36 can be suppressed further, thereby making it possible to enhance further the reliability of the optical connector.

The optical connector ferrule and the optical connector according to the invention are not limited to the embodiment and the modified examples, and other modifications can be made thereto. For example, the embodiment and the individual modified examples may be combined together as required according to required objects and advantageous effects. In the embodiment and the modified examples, the first inner lateral surfaces, the second inner lateral surfaces and the bottom surface are described as being flat and being formed into the curved surface. However, in the present invention, the first inner lateral surfaces, the second inner lateral surfaces and the bottom surface may be formed into other smooth surfaces.

In the embodiment, the plurality of optical fibers are described as being aligned into the row. However, the present invention can also be applied to an optical connector and an optical connector ferrule (for example, a 24-core ferrule, a 48-core ferrule) in which optical fibers are aligned into a plurality of rows (in multiple stages). In the embodiment, the front end face and the rear end face, which face each other, are described as being parallel. However, the present invention can also be applied to an optical connector and an optical connector ferrule in which a front end face and a rear end face are not parallel.

### REFERENCE SIGNS LIST

1A: optical connector; 10, 10A to 10D: optical connector ferrule; 10a: front end face; 10b: rear end face; 10c, 10d: lateral surface; 10e: upper surface; 10f: lower surface; 12: fiber holding hole; 12a: front portion; 12b: rear portion; 14: opening; 15: adhesive introduction window; 15a, 15b: inner lateral surface; 20, 20A to 20D: fiber introduction space; 21: fiber supporting surface; 21a: guide groove; 22a to 22f: first inner lateral surface; 23a to 23d: second inner lateral surface; 24, 24a: bottom surface; 30: optical fiber ribbon; 31: optical fiber; 32: glass portion; 33: first resin covering; 34 second resin covering; 36: bare fiber; P1: imaginary plane; V11, V12, V21, V22, V3: normal vector.

1. An optical connector ferrule, having:
a pair of end faces aligned in a first direction;
a plurality of fiber holding holes extending in the first direction between the pair of end faces, and aligned in a second direction intersecting the first direction to hold a plurality of optical fibers individually; and
a fiber introduction space having an opening at one of the end faces, communicating with the plurality of fiber holding holes, and receiving the plurality of optical fibers collectively,
wherein an inner surface defining the fiber introduction space includes:
a fiber supporting surface having a plurality of guide grooves formed in such a way as to extend individually from ends of the plurality of fiber holding holes towards the one end face; and
a pair of first inner lateral surfaces extending individually from both ends of the fiber supporting surface in the second direction, and
wherein a space between the pair of first inner lateral surfaces expands gradually as further away from the fiber supporting surface.

2. The optical connector ferrule according to claim 1,
wherein the pair of first inner lateral surfaces are flat, and a normal of each of the pair of first inner lateral surfaces is inclined relative to the second direction.

3. The optical connector ferrule according to claim 1,
wherein in a section normal to the first direction, the pair of first inner lateral surfaces are curved.

4. The optical connector ferrule according to claim 1,
wherein the inner surface defining the fiber introduction space further includes a pair of second inner lateral surfaces extending individually from ends of the pair of first inner lateral surfaces in the first direction towards the opening, and
wherein a space between the pair of second inner lateral surfaces expands gradually as further away from the pair of first inner lateral surfaces.

5. The optical connector ferrule according to claim 4,
wherein the pair of second inner lateral surfaces are flat, and a normal of each of the pair of second inner lateral surfaces is inclined relative to the second direction.

6. The optical connector ferrule according to claim 4,
wherein in a section including the first direction and the second direction, the pair of second inner lateral surfaces are curved convexly towards the fiber introduction space.

7. The optical connector ferrule according to claim 1,
wherein the inner surface defining the fiber introduction space further includes a bottom surface extending from an end of the fiber supporting surface in the first direction towards the opening, and
wherein the bottom surface gradually extends away from an imaginary plane including the fiber supporting surface as further away from the fiber supporting surface.

8. The optical connector ferrule according to claim 7,
wherein the bottom surface is flat and is inclined relative to the first direction.

9. The optical connector ferrule according to claim 7,
wherein in a section normal to the second direction, the bottom surface is curved convexly towards the fiber introduction space.

10. An optical connector, comprising:
the optical connector ferrule according to claim 1; and
the plurality of optical fibers introduced into the fiber introduction space collectively from the opening and held individually in the plurality of fiber holding holes.
